(19) United States
(12) Patent Application Publication
(10) Pub. No.: US 2008/0070042 A1
(43) Pub. Date: Mar. 20, 2008

(54) PRINTING BLANKET OR SLEEVE INCLUDING THERMOPLASTIC POLYURETHANE OR THERMOPLASTIC POLYURETHANE ALLOY LAYERS

(75) Inventors: Joseph L. Byers, Inman, SC (US); W. Toriran Flint, Asheville, NC (US); Samuel R. Shuman, Bozeman, MT (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: DAY INTERNATIONAL, INC., Dayton, OH (US)

(21) Appl. No.: 11/857,995

(22) Filed: Sep. 19, 2007

Related U.S. Application Data
(60) Provisional application No. 60/845,949, filed on Sep. 20, 2006.
(60) Provisional application No. 60/891,294, filed on Feb. 23, 2007.

(51) Int. Cl. B32B 27/40; B05D 1/26; B05D 1/36

(52) U.S. Cl. 428/423.1; 427/322; 427/407.1

(57) ABSTRACT

An image transfer product such as a printing blanket or sleeve is provided which includes at least a base layer, a printing surface layer, and an optional intermediate compressible layer, where one or more of the layers is formed from a thermoplastic polyurethane or thermoplastic polyurethane alloy. The thermoplastic polyurethane compressible layer has a plurality of voids therein introduced by the use of pre-expanded or unexpanded microspheres. The resulting blanket or sleeve exhibits good resistance to compression.

### CROSS-REFERENCE TO RELATED APPLICATIONS

This application claims the benefit of U.S. Provisional Application No. 60/845,949, filed Sep. 20, 2006, entitled IMAGE TRANSFER PRODUCT WITH THERMOPLASTIC POLYURETHANE FOAM AND/OR THERMOPLASTIC POLYURETHANE ALLOY FOAM, and U.S. Provisional Application No. 60/891,294, filed Feb. 23, 2007, entitled IMAGE TRANSFER PRODUCT COMPRISING THERMOPLASTIC POLYURETHANE LAYERS. The entire contents of said applications are hereby incorporated by reference.

### BACKGROUND OF THE INVENTION

The present invention relates to a printing blanket or printing sleeve for use in offset printing applications, and more particularly, to a printing blanket or sleeve which includes one or more layers formed from a thermoplastic polyurethane or thermoplastic polyurethane alloy.

One of the most common commercial printing processes is offset lithography. In this printing process, ink is offset from a printing plate to a rubber-surfaced printing blanket or cylindrical sleeve mounted on a blanket cylinder before being transferred to a substrate, such as paper. Typically, the printing blanket or sleeve includes at least one base layer comprised of metal or fabric, and a printing surface layer formed from a polymeric rubber material which is adapted to carry and transfer liquid printing ink. The blanket or sleeve also typically includes an intermediate compressible layer.

However, most printing surface layers currently in use typically comprise natural or synthetic rubber materials which require the use of a solvent to dissolve the rubber material so that it may be coated, in numerous thin passes, onto the base ply. The solvent must then be evaporated prior to curing. Alternatively, the natural or synthetic rubber materials may be calendered onto the base ply in a single pass, but at great expense due to the need to adequately control gauge. In both methods, the rubber must be cured under pressure, which is a time consuming process.

Compressible layers currently in use are typically comprised of materials such as synthetic rubbers, rubber blends, and cast urethane, which have been processed into a cellular, or foam, form containing voids. Again, the use of rubbers typically requires the use of solvents to dissolve the rubber material for processing, which must then be evaporated prior to curing. Cast urethanes can also present complications in processing as their pot life must be carefully controlled, and this can lead to difficulty in mixing, casting and curing.

As the compressible layer allows positive displacement of the printing surface layer without causing distortion of the image, the compressible layer must exhibit good recovery from impact in order to be effective. Generally, the ability of the blanket to resist permanent compression determines its useful life, thus the compressible layer is typically the layer that limits the longevity of the blanket. As such, it would be desirable to form a compressible layer with materials which improve the ability of the compressible layer to resist permanent compression set and subsequently, improve the longevity of the printing blanket.

Accordingly, there is a need in the art for an image transfer product such as a printing blanket or sleeve formed from layers which may be easily processed, which provides the desired gauge and texture for printing, and which exhibits resistance to permanent compression.

### SUMMARY OF THE INVENTION

The present invention meets those needs by providing an offset printing blanket or sleeve including one or more layers which has been formed from a thermoplastic polyurethane (TPU) or thermoplastic polyurethane alloy. The use of thermoplastic polyurethane materials provides an advantage over previously used polymeric rubber materials as the thermoplastic polyurethanes are supplied and processed in 100% solids form, eliminating the need for solvents.

According to one aspect of the present invention, a printing blanket or sleeve is provided comprising at least a base layer, a compressible layer comprising a thermoplastic polyurethane or a thermoplastic polyurethane alloy, where the compressible layer has voids therein; and a printing surface layer.

The thermoplastic polyurethane preferably comprises a polyester-based polyurethane. The thermoplastic polyurethane alloy preferably comprises a TPU alloyed with a nitrile rubber, EPDM, polysulfide, or butyl rubber.

In one embodiment of the invention, the base layer of the blanket or sleeve may comprise a fabric, a metal, or a polymeric material. In another embodiment, the base layer may comprise a thermoplastic polyurethane or thermoplastic polyurethane alloy.

The printing surface layer may comprise a polymeric rubber material. In an alternative embodiment, the printing surface layer comprises a thermoplastic polyurethane or a thermoplastic polyurethane alloy.

In accordance with another aspect of the invention, a printing blanket or sleeve is provided comprising a base layer comprising a thermoplastic polyurethane or thermoplastic polyurethane alloy, and a printing surface layer comprising a thermoplastic polyurethane or thermoplastic polyurethane alloy. The printing blanket or sleeve may further include a compressible layer positioned between the base layer and the printing surface layer, where the compressible layer comprises a thermoplastic polyurethane or a thermoplastic polyurethane alloy having voids therein. In this embodiment, the printing surface layer preferably comprises a thermoplastic polyurethane alloy, and more preferably, a thermoplastic polyurethane/nitrile alloy.

The printing blanket or sleeve of this embodiment may further include an image reinforcement layer positioned below the printing surface layer. The image reinforcement layer may comprise a fabric, a thermoplastic polyurethane, or a thermoplastic polyurethane alloy. Preferably, the image reinforcement layer comprises a thermoplastic polyurethane having a Shore A hardness which is greater than the Shore A hardness of the printing surface layer. Preferably, the image reinforcement layer has a Shore A hardness of between about 70 to 95.

The printing blanket or sleeve of this embodiment may further include one or more reinforcing fabric layers positioned between the base layer and the printing surface layer. Where an image reinforcement layer is included in the construction, the reinforcing fabric layer is preferably positioned below the image reinforcement layer.

According to another aspect of the invention, a method of making a printing blanket or sleeve including a compressible layer is provided comprising providing a base substrate web or sleeve; providing a source of thermoplastic polyurethane or thermoplastic polyurethane alloy in liquid form including a void-producing material; extruding the thermoplastic polyurethane or thermoplastic polyurethane alloy over substantially the entire surface of the base substrate or sleeve to form a compressible layer thereon; and providing a printing surface layer over the compressible layer.

The void-producing material is selected from the group consisting of pre-expanded microspheres, unexpanded microspheres, and blowing agents. Alternatively, the voids may be created by incorporating a leachable material that is subsequently removed after formation of the layer or by whipping air into the thermoplastic polyurethane while it is in a liquid state.

In one embodiment of the method, the void-producing material comprises unexpanded microspheres, and the method of extruding the thermoplastic polyurethane or thermoplastic polyurethane alloy further comprises expanding the microspheres. In an alternative embodiment, the void-producing material comprises unexpanded microspheres, wherein the microspheres are expanded by heating after extrusion of the compressible layer.

In another embodiment of the invention, a method of making a printing blanket or sleeve including a compressible layer is provided comprising providing a base layer comprising a substrate web or sleeve; applying a compressible layer comprising a thermoplastic polyurethane or thermoplastic polyurethane alloy to the substrate web or sleeve; and providing a printing surface layer over the compressible layer. In this embodiment, the compressible layer may be in the form of a film or sheet which is laminated to the base layer.

The base layer may comprise a fabric, metal, polymer, or a thermoplastic polyurethane or thermoplastic polyurethane alloy. The printing surface layer may comprise a rubber, polymer, or thermoplastic polyurethane or thermoplastic polyurethane alloy.

The method may further include providing an image reinforcement layer below the printing surface layer.

In yet another embodiment of the invention, the method of making a printing blanket or sleeve comprises providing a base layer comprising a substrate web or sleeve and providing a printing surface layer over the base layer; where the base layer and the printing surface layer comprise a thermoplastic polyurethane or a thermoplastic polyurethane alloy.

Accordingly, it is a feature of embodiments of the present invention to provide a printing blanket or sleeve in which at least one of the base layer, compressible layer, or printing surface layer is formed from a thermoplastic polyurethane or thermoplastic polyurethane alloy. Other features and advantages of the invention will be apparent from the following description, the accompanying drawings, and the appended claims.

### BRIEF DESCRIPTION OF THE DRAWINGS

FIG. 1 is a perspective view of a printing blanket including a TPU compressible layer; and

FIG. 2 is a cross-section of a printing sleeve including a TPU base layer, a TPU compressible layer, and a TPU printing surface layer.

### DETAILED DESCRIPTION OF THE PREFERRED EMBODIMENT

The properties of thermoplastic polyurethanes (TPUs) give them a distinct processing advantage for use as layers in a blanket or sleeve construction. The use of TPUs or TPU alloys provides flexibility in designing a blanket or sleeve having the desired properties for use in offset printing. Further, TPUs do not require the use of solvents in processing, which saves time, cost, and effort in adding, drying, and recovering solvents in addition to initial purchase of the solvents. Furthermore, TPUs do not cure like traditional rubber materials used in blanket constructions, affording additional process time and energy savings. TPUs also provide an advantage in that they are easily colorable and recyclable. Further, TPUs maintain their elastomeric behavior over a wide temperature range, and they have a high rebound ability and improved cohesive strength, resulting in longer life for the blanket or sleeve in which they are incorporated.

Thermoplastic polyurethanes are formed by reacting a difunctional isocyanate composition with at least one difunctional polyhydroxy compound and optionally a chain extender. Unlike cast urethanes, TPUs consist of block copolymer molecules with alternating hard and soft segments. This combination allows TPUs to have high elasticity, low glass transition temperatures, high melting points, and elastomeric character. By adjusting the ratio of hard and soft segments, many properties can be adjusted over a wide range, including tear and tensile strength, hardness, stiffness, and elasticity.

Suitable thermoplastic polyurethanes that are suitable for use in the present invention are polyester or polyether-based and include those commercially available from Huntsman Polyurethanes, Dow and Bayer. Polyester-based polyurethanes are preferred for use due to their chemical resistance. Alloys of the above-described thermoplastic polyurethanes with conventional rubber materials such as nitrile rubber, EPDM, polysulfide, and butyl rubber may also be used.

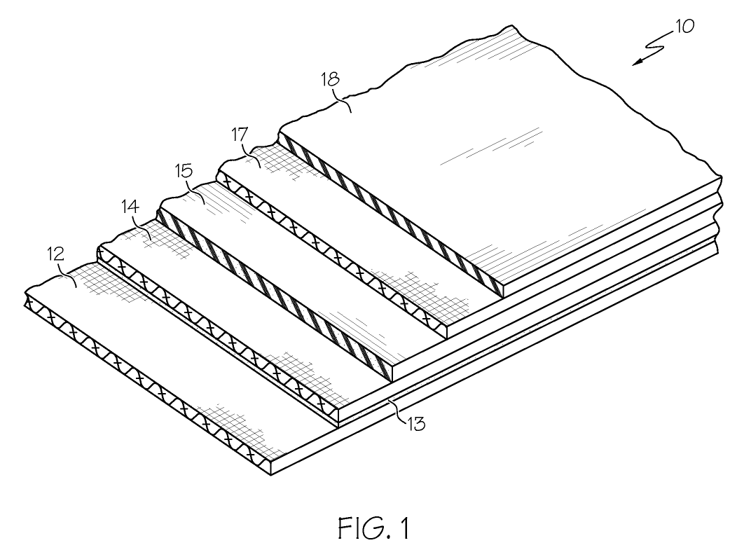

Referring now to FIG. 1, one embodiment of the invention is shown in the form of a printing blanket 10. It will be appreciated that the layers as shown in the blanket construction are also applicable to a sleeve construction. The printing blanket 10 is shown comprising a base layer 12, a compressible layer 15, and a printing surface layer 18. The blanket optionally may include additional layers such as, for example, fabric reinforcing ply or layer 14 and image reinforcing ply or layer 17. The various blanket plies or layers may be secured to one another using a suitable adhesive 13. In the embodiment shown, base layer 12 comprises a fabric layer. It should be appreciated that more than one base layer may be included in the construction. In this embodiment, the printing surface layer 18 comprises a polymeric rubber material, but may alternatively comprise a TPU or TPU alloy.

The base layer may alternatively be comprised of a TPU or TPU alloy which provides support when the blanket is placed under tension. Where the blanket is tensioned, the base layer should have a coefficient of friction which facilitates even tensioning of the blanket around a printing cylinder. This may be achieved with the use of TPU or TPU alloys, or TPU reinforced with fibers, a TPU/textile composite, or the use of a thermoplastic material such as Delrin™ (polyoxy-methylene). Where the blanket is non-tensioned, a metal base layer may be used, or any of the above TPU materials may be used as long as they provide the desired low elongation properties.

The compressible layer 15 is comprised of a thermoplastic polyurethane (TPU) and/or a TPU alloy. TPUs and alloys thereof can be formed into compressible layers by introducing voids within the TPU material. These voids may be induced by using techniques that include the incorporation of pre-expanded microspheres, unexpanded microspheres that expand with the thermal processing of the starting material, or the use of endothermic or exothermic blowing agents. Other suitable techniques include the incorporation and subsequent removal of leachable additives, mechanical whipping of the material, and/or the incorporation of low-boiling liquid additives.

The ability to control void gauge and percentage void content varies, depending on the method in which the voids are introduced. The use of microspheres is preferred for introducing voids into the thermoplastic polyurethane. Microspheres can be incorporated into the TPU compound prior to TPU pellet formation or as an additive during thermal processing such as extrusion as explained below.

When using pre-expanded microspheres, care must be taken so that the voids are not destroyed by thermal processing that relies on shear, such as extrusion.

The use of unexpanded microspheres is preferred for use in the present invention. Such microspheres expand with heat and can be added during extrusion and expanded as the TPU mixture exits an extrusion die as described below or subsequent to extrusion with the application of additional heat. Void gauge is controlled by the proper application of heat, the rate of cooling, and the pressure applied to the layer during layer formation and/or lamination. Percentage void content for either pre-expanded or unexpanded microspheres is a function of void gauge, the number of spheres added, and their uniform distribution within the compressible layer.

The TPU compressible layer is preferably produced using unexpanded microspheres dispersed in, for example, ethylene vinyl acetate, and a thermoplastic polyurethane having a Shore A hardness of from about 55 to 70.

Suitable methods of incorporating microspheres in a TPU are disclosed in European Patent Applications EP 1 174 459 A1 and EP 1 233 037 A2, and PCT applications WO 01/10950, and WO 00/44821, the subject matter of which are incorporated herein by reference.

Where the TPU compressible layer is produced using expanded microspheres, the temperature of the TPU during the application process should be kept below the expansion temperature of the microspheres so that the amount of expansion will remain constant during the processing of the compressible layer.

Where the TPU compressible layer is produced using unexpanded microspheres, the TPU may be heated just to or slightly above the expansion temperature of the TPU during extrusion such that the expansion occurs at or near the exit of the extrusion die. The still soft TPU is then passed through a calibrating nip to achieve the desired gauge. Alternatively, the temperature of the TPU may be kept below the expansion temperature of the microspheres during the extrusion process and subsequently brought just to or slightly above the expansion temperature of the microspheres. In this case, the softening point of the TPU should be matched relatively closely to the expansion temperature of the microspheres so that it can deform to accommodate the expansion. One method of raising the temperature of the TPU to the expansion temperature of the microspheres is to pass the extruded TPU film containing the unexpanded microspheres through a heated nip or series of heated nips so that the temperature of the composite is gradually raised to the expansion temperature of the microspheres and expansion occurs under pressure to control the total gauge of the compressible layer. This temperature exceeds the temperature reached during compounding and extrusion, allowing the material to soften and the microspheres to expand under pressure, controlling the amount of expansion.

Alternatively, endothermic and/or exothermic blowing agents may be introduced into the TPU material during initial compounding/manufacturing of the TPU and prior to TPU pellet formation or, preferably, during thermal processing. Blowing agents decompose when their activation temperature is reached and release gas upon decomposition. Endothermic blowing agents absorb energy during decomposition and tend to release less gas than exothermic agents, approximately 110 ml/g. Such blowing agents are useful in producing finer and more homogeneous foams.

Exothermic blowing agents emit energy during decomposition and tend to release more gas than endothermic agents, approximately 220 ml/g. They are useful in producing foams with larger void gauge. The void gauge and percentage void content is dependent on the amount and type of blowing agent, heat, the rate of cooling, and the pressure applied to the layer during layer formation and lamination.

Leachable additives such as various salts, sugars, or other selectively soluble materials can also be added to the TPU in the compounding stage or during thermal processing. Once the leachable additives are incorporated, voids will not be induced until the TPU layer is formed. At this point, the TPU layer must be brought into contact with an appropriate solvent that will dissolve or leach out the additives without degrading the layer. With the additives thus removed, voids remain in the layer. The gauge of these voids is determined by the gauge of the particulate additive selected, while the percentage void content is a function of the quantity and distribution of the additive and degree of removal.

Mechanical whipping of the molten TPU can also be employed to introduce voids with the layer. For example, when the TPU has been melted by thermal processing by extrusion or other means, the TPU can be agitated by mechanical means such that air or other gases are incorporated. Such mechanical means can include stirring, beating, whipping, or any other mechanical process in which air or other gases are forcibly mixed into the molten material. Alternatively, air or other gases may be injected into the molten TPU and mixed to disperse the air/gas evenly throughout. The whipped/mixed material can then be formed into an appropriate layer. Void gauge and percentage void content is mechanically controlled by the severity of the whipping/mixing process, the amount of air or gas introduced, and by the geometry of whipping/mixing equipment such as agitators, screws, and paddles.

Low-boiling liquid additives such as fluorocarbons or chlorocarbons can also be incorporated during thermal processing of the TPU. However, selection of the liquid and thermal processing parameters must be done with care so that the liquid is intermixed well within the TPU prior to boiling. When the boiling occurs, voids are formed within the material that will be retained when the TPU material cools during layer formation. The void gauge and percentage void content are determined by the amount and type of liquid added, the balance of heat and cooling, and the pressure applied to the layer during formation and lamination.

While the compressible layer has been described herein as comprising a TPU layer, it should also be appreciated that the compressible layer, in certain blanket/sleeve constructions, may comprise a polymeric rubber layer. Such a compressible polymeric rubber layer may be incorporated with voids as described above.

The compressible layer preferably has a thickness of from about 0.006 inches to about 0.100 inches (about 0.15 mm to 2.54 mm), and more preferably, from about 0.010 inches to about 0.060 inches (about 0.25 mm to 1.5 mm).

The base layer is typically about 0.010 inches to about 0.026 inches (about 0.25 mm to 0.66 mm) thick, and the printing surface layer is typically between about 0.010 inches to 0.025 inches (about 0.25 mm to 0.64 mm) thick. However, it should be appreciated that the thickness of the base layer and printing surface layer may vary, depending on the materials selected for the layers and the desired finished blanket/sleeve properties.

In the preferred method of making a printing blanket or sleeve including the thermoplastic polyurethane compressible layer 15, a base layer 12 is provided on a printing blanket or sleeve, and the thermoplastic polyurethane compressible layer is either extruded in liquid form as described above or is laminated to the base layer with the use of heat and/or adhesives. The printing surface layer 18 may be applied to the compressible layer 15 by adhesive bonding, heat lamination, or direct extrusion.

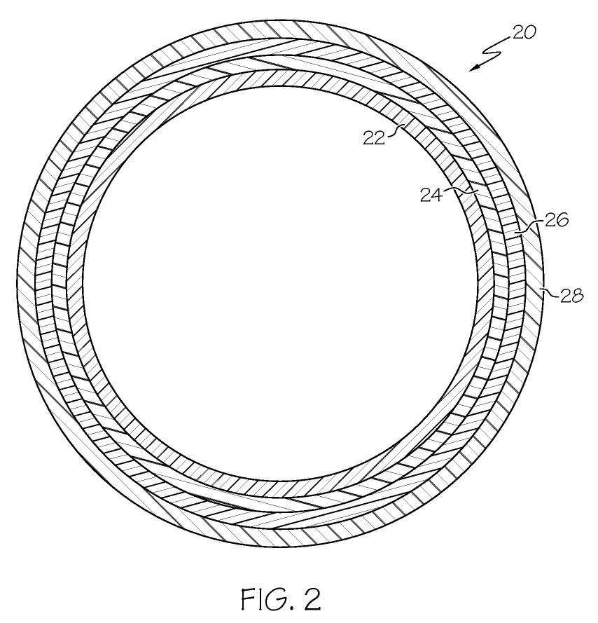

FIG. 2 illustrates another embodiment of the invention in the form of a printing sleeve 20 in which all of the layers in the sleeve have been formed from a thermoplastic polyurethane or a thermoplastic polyurethane alloy. It will be appreciated that the layers as shown in the sleeve construction are also applicable to a blanket construction. As shown, the sleeve includes base layer 22, an optional compressible layer 24, an optional image reinforcement layer 26, and a printing surface layer 28.

The base layer 22 is comprised of a low elongation, high tensile strength TPU and/or TPU alloy as described above. The optional image reinforcement layer 26 is positioned beneath the printing surface layer 28 and preferably comprises a hard TPU and/or TPU alloy, which functions to stabilize the printing surface layer 28 and protect the underlying compressible layer 24, when present. The thickness, hardness and elongation of the image reinforcement layer may be modified as desired by the selection of the TPU materials to provide a means of adjusting and varying the feed rate of the product as needed for the particular printing press design. This provides an improvement over textile materials which have previously been used as image reinforcement layers.

The image reinforcement layer preferably has a Shore A hardness ranging from 70 to 95, and more preferably, from about 80 to 90. This TPU material is preferably blended with other polymers or other suitable processing aids to reduce tack and aid in processing.

In the embodiment shown in FIG. 2, printing surface layer 28 comprises a relatively soft and non-plasticized TPU and/or TPU alloy. Suitable TPU alloys include nitrile rubber, isobutylene-isoprene, polysulfide rubber, EPDM terpolymer, natural rubber, and styrene butadiene rubber. The alloys may further include fillers and/or surface treatments.

The printing surface layer preferably comprises a TPU/nitrile rubber alloy and a mineral additive such as talc. The talc is preferably included at a loading of between about 1% and 35% and functions as an aid during the mechanical surface finishing (grinding) process, i.e., it functions to reduce frictional heat build-up during grinding.

The printing surface layer preferably exhibits a Shore resilience of less than 40%, and an average surface roughness of less than about 0.5 microns. By “Shore resilience,” it is meant the vertical rebound of the layer is measured pursuant to ASTM 2632.

The desired characteristics of the printing surface profile can be provided by thermal forming either before or after applying the TPU or TPU alloy material onto the blanket/sleeve composite. Alternatively, the desired surface profile can be mechanically imparted by abrasion/grinding, or chemically etching or leaching after application of the TPU material to the blanket/sleeve composite.

In embodiments where each of the base layer, optional compressible layer, optional image reinforcement layer, and printing surface layer are comprised of TPU or TPU alloys, such layers may be provided in the form of free or supported films. The layers may be adhered to adjacent layer(s) of the blanket construction by bonding methods well known in the art, or by heat lamination or direct extrusion onto the blanket construction. The layers may also be extrusion-laminated or slot-die coated to adjacent layers, or may be co-extruded with adjacent layers. It should be appreciated that the layers may also be adhered with the use of conventional adhesives. Alternatively, the TPU materials comprising the layers may be softened by the application of heat such that they function as adhesives.

The preferred embodiments of the present invention exclude the use of fabrics as we have found that the omission of fabric layers in the construction minimizes the wicking of solvents and other chemicals from the printing press into the blanket or sleeve layers, which can cause swelling and delamination of the layers. However, fabric layers may be incorporated into the construction as long as the blanket or sleeve edges are sealed and/or the fabric is sufficiently impregnated with a suitable TPU material to prevent wicking of solvents/chemicals. Where the blanket or sleeve layers are comprised primarily of TPU or TPU alloys, edge sealing is readily achieved by heating the exposed edges of the blanket, allowing the thermoplastic material to soften and flow together. Alternatively, additional TPU or TPU alloy may be added with heat to the exposed edges. The added TPU or TPU alloy will bond readily to the blanket cross-section due to its thermoplastic nature.

Where one or more fabric layers are used as a reinforcing layer (for example, as shown in FIG. 1), the preferred fabric exhibits an elongation of about 4 to 16% and a minimum tensile strength of 60 pounds per inch (27.21 kg per cm). The edges of the fabric layers may be sealed with a TPU material or impregnated with TPU or a TPU alloy as described above such that the desired properties are maintained and the fabric no longer retains significant wicking properties.

In embodiments where the blanket or sleeve includes a compressible layer comprised of a TPU or TPU alloy foam, the blanket or sleeve should preferably exhibit a static compressibility of about 0.14 to 0.22 mm at 1060 kPA, or about 0.21 to 0.29 mm at 2060 kPa. The blanket or sleeve including the compressible layer should also exhibit a dynamic gauge loss of less than about 0.025 mm. The blanket or sleeve should also exhibit solvent/swelling resistance. Preferably, in distilled water, the blanket or sleeve should exhibit a volume swell of less than 2.5%; in 3.125% fountain solution, less than 3.0%; in 10% fountain solution, less than 3.5%; and in blanket wash, less than 2.0%.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What is claimed is:

1. A printing blanket or sleeve comprising:
a base layer;
a compressible layer comprising a thermoplastic polyurethane or a thermoplastic polyurethane alloy, said compressible layer having voids therein; and
a printing surface layer.

2. The blanket or sleeve of claim 1 wherein said thermoplastic polyurethane comprises a polyester-based polyurethane.

3. The blanket or sleeve of claim 1 wherein said compressible layer comprises an alloy of a thermoplastic polyurethane with a material selected from nitrile rubber, EPDM, polysulfide, and butyl rubber.

4. The blanket or sleeve of claim 1 wherein said base layer comprises a fabric, metal, or a polymeric material.

5. The blanket or sleeve of claim 1 wherein said base layer comprises a thermoplastic polyurethane or thermoplastic polyurethane alloy.

6. The blanket or sleeve of claim 1 wherein said printing surface layer comprises a rubber or polymeric material.

7. The blanket or sleeve of claim 1 wherein said printing surface layer comprises a thermoplastic polyurethane or thermoplastic polyurethane alloy.

8. A printing blanket or sleeve comprising:
a base layer comprising a thermoplastic polyurethane or thermoplastic polyurethane alloy; and
a printing surface layer comprising a thermoplastic polyurethane or thermoplastic polyurethane alloy.

9. The printing blanket or sleeve of claim 8 further including a compressible layer positioned between said base layer and said printing surface layer comprising a thermoplastic polyurethane or a thermoplastic polyurethane alloy, said compressible layer having voids therein.

10. The printing blanket or sleeve of claim 8 wherein said printing surface layer comprises a thermoplastic polyurethane alloy.

11. The printing blanket or sleeve of claim 10 wherein said printing surface layer comprises an alloy of thermoplastic polyurethane with a material selected from nitrile rubber, EPDM, polysulfide and butyl rubber.

12. The printing blanket or sleeve of claim 8 further including an image reinforcement layer positioned below said printing surface layer comprising a fabric, a thermoplastic polyurethane, or a thermoplastic polyurethane alloy.

13. The printing blanket or sleeve of claim 12 wherein said image reinforcement layer comprises a thermoplastic polyurethane having a Shore A hardness which is greater than the Shore A hardness of said printing surface layer.

14. The printing blanket or sleeve of claim 13 wherein said image reinforcement layer has a Shore A hardness of between about 70 to 95.

15. The printing blanket or sleeve of claim 8 further including a reinforcing fabric layer positioned below said printing surface layer.

16. A method of making a printing blanket or sleeve including a compressible layer comprising:
providing a base substrate web or sleeve;
providing a source of thermoplastic polyurethane or thermoplastic polyurethane alloy in liquid form including a void-producing material;
extruding said thermoplastic polyurethane or thermoplastic polyurethane alloy over substantially the entire surface of said base substrate or sleeve to form a compressible layer thereon; and
providing a printing surface layer over said compressible layer.

17. The method of claim 16 wherein said void-producing material is selected from the group consisting of pre-expanded microspheres, unexpanded microspheres, blowing agents, and leachable additives.

18. The method of claim 17 wherein said void-producing material comprises unexpanded microspheres and wherein extruding said thermoplastic polyurethane or thermoplastic polyurethane alloy further comprises expanding said microspheres.

19. The method of claim 17 wherein said void-producing material comprises unexpanded microspheres and wherein said microspheres are expanded by heating after extrusion of said compressible layer.

20. A method of making a printing blanket or sleeve including a compressible layer comprising:
providing a base layer comprising a substrate web or sleeve;
applying a compressible layer comprising a thermoplastic polyurethane or thermoplastic polyurethane alloy to said substrate web or sleeve; said compressible layer including voids therein; and
providing a printing surface layer over said compressible layer.

21. The method of claim 20 wherein said compressible layer is laminated to said base layer.

22. The method of claim 20 wherein said base layer comprises a fabric, metal, polymer, or a thermoplastic polyurethane or thermoplastic polyurethane alloy.

23. The method of claim 20 wherein said printing surface layer comprises a rubber, polymer, or thermoplastic polyurethane or thermoplastic polyurethane alloy.

24. The method of claim 20 further including providing an image reinforcement layer between said compressible layer and said printing surface layer.

25. A method of making a printing blanket or sleeve comprising:
providing a base layer comprising a substrate web or sleeve; said base layer comprising a thermoplastic polyurethane or thermoplastic polyurethane alloy; and
providing a printing surface layer over said base layer; said printing surface layer comprising a thermoplastic polyurethane or thermoplastic polyurethane alloy.
